(19) United States
(12) Patent Application Publication
(10) Pub. No.: US 2011/0318129 A1
(43) Pub. Date: Dec. 29, 2011

(54) Auger Bit

(76) Inventor: Arthur A. Piper, Loves Park, IL (US)

(21) Appl. No.: 12/822,941

(22) Filed: Jun. 24, 2010

(51) Int. Cl. B27G 15/00; B23P 15/32; B23B 51/02

(52) U.S. Cl. 408/214; 76/102

(57) ABSTRACT

An auger bit and a method of manufacturing the auger bit it is described. The auger bit has an axially-elongated shank portion, a tool-engaging portion on a first end of the shank, and a work-entering head portion on a second end of the shank. The machined bit is neutral heat treated and the cutting face is locally hardened by induction heat treating.

### FIELD OF THE INVENTION

The present invention relates to auger bits for forming bores in materials, such as wood and the like, and in particular in wood with nails.

### BACKGROUND OF THE INVENTION

Bore-drilling auger bits are used to form bores in workpieces such as wood and the like. These auger bits are commonly used in construction and electrical installations. Sometimes other materials, such as nails, occur in the workpiece. For example, when an electrician drills through a wooden joist or a wall stud to form a bore for conduit, the auger bit may encounter a nail, increasing the difficulty of forming the bore. While many auger bits will serve the purpose of forming a bore, even through nails extending through the bore path, such auger bits quickly become dull and various features of the auger bit may even fail during the boring operation.

An auger bit as is known in the prior art is described in, for example, U.S. Pat. No. 5,244,319 to Cochran, Auger Bit. An auger bit generally comprises an axially-elongated shank portion, a tool-engaging portion on a first end of the shank, and a work-entering head portion on a second end of the shank. The work-entering head portion comprises a cutting face.

The tool-engaging portion is conventionally a formed end of the shank and is configured for retention in a chuck portion of a bit-driving tool, such as a drill. The work-entering head portion conventionally has a threaded lead screw ahead of the cutting face. It is preferable to the user that the cutting face not have cracks, as cracks detract from the performance of the auger bit.

It is known to manufacture auger bits by machining the components of the auger bit from a blank piece of metal and neutral heat treating the entire product. Neutral heat treating comprises heating a basket of machined auger bits in a furnace, typically an atmosphere-controlled batch furnace, rapidly cooling or “quenching” the auger bits, typically in a tank of oil, rinsing the quenching fluid, and tempering the auger bits in a tempering furnace. This method achieves a uniform hardness throughout the entire auger bit, usually in the range of 40 to 50 on the Rockwell C scale (“Rc”).

### BRIEF SUMMARY OF THE INVENTION

Briefly, the present invention in one aspect comprises an auger bit with an axially-elongated shank portion, a tool-engaging portion on a first end of the shank, and a work-entering head portion on a second end of the shank. The work-entering head portion comprises a cutting face. The machined bit is neutral heat treated and the cutting face is locally hardened by induction heat treating. In another aspect, the present invention comprises a method of manufacturing an auger bit, comprising the steps of machining a tool-engaging portion on a first end of an axially-elongated shank and a work-entering head portion on a second end of the shank, the work-entering head portion comprising a cutting face, neutral heat treating the machined shank, and locally heat treating the cutting face by induction.

### BRIEF DESCRIPTION OF THE SEVERAL VIEWS OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a side view of an auger bit of the preferred embodiment of the present invention;

FIG. 2 is a side view of the second end of the auger bit of FIG. 1;

FIG. 3 is an axial cross-sectional view of the second end of the auger bit of FIG. 2;

FIG. 4 is a radial cross-sectional view of the second end of the auger bit of FIG. 2; and

FIG. 5 is an end view of the second end of the auger bit of FIG. 2.

### DETAILED DESCRIPTION OF THE PREFERRED EMBODIMENT OF THE INVENTION

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

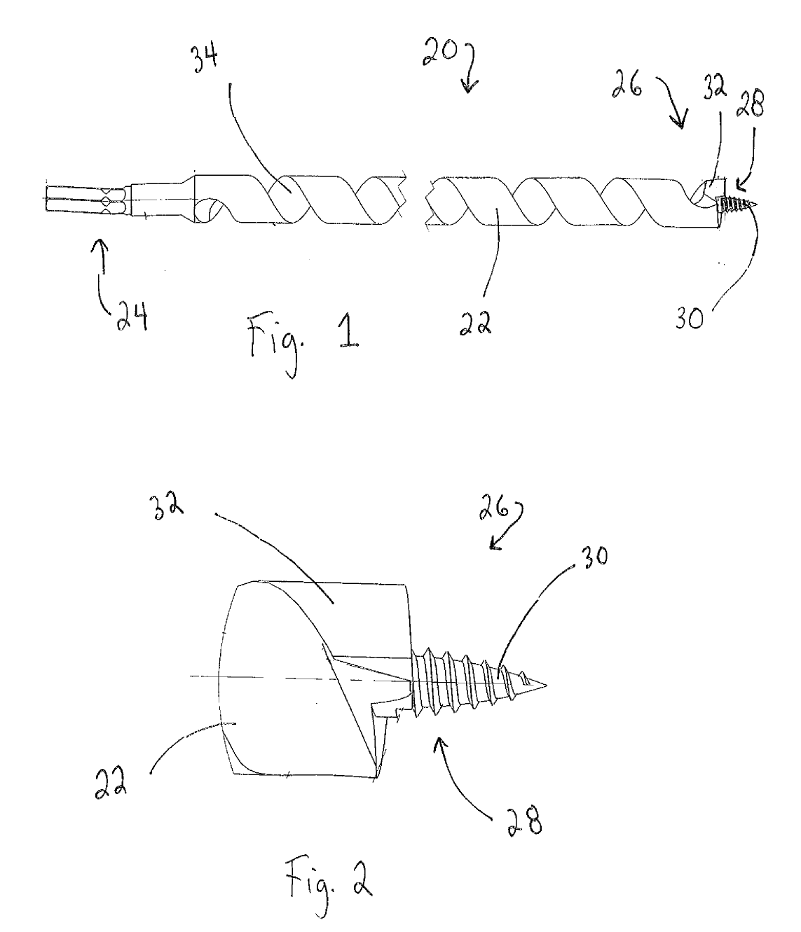

An auger bit 20 is shown in FIG. 1. The auger bit 20 has a shank portion 22 having a first end 24 and a second end 26. The first end 24 is configured for engaging a driver and preferably is machined to have a hexagonal cross-section into order to engage a self-centering three-jaw chuck of a drill. The first end 24 can have other shapes, including a circular cross-section or a flat cross-section. The first end 24 can also be configured for engagement to a tool by other means, such as an independent jaw chuck, a collet, or a special direct system.

The auger bit 20 has a work-entering head portion 28 at the second end 26, as shown in more detail in FIG. 2. The head portion 28 preferably comprises a threaded lead screw 30 and a cutting face 32, most preferably as described in U.S. Pat. No. 5,244,319, the disclosure of which is incorporated by reference herein. Preferably, the auger bit 20 also has a helical flute 34 extending from the cutting face 32 toward the first end 24. The entire auger bit 20 is first neutral hardened and then an induction heat-treat zone 40 in cutting face 32 is locally hardened by induction heat treatment as explained in more detail below.

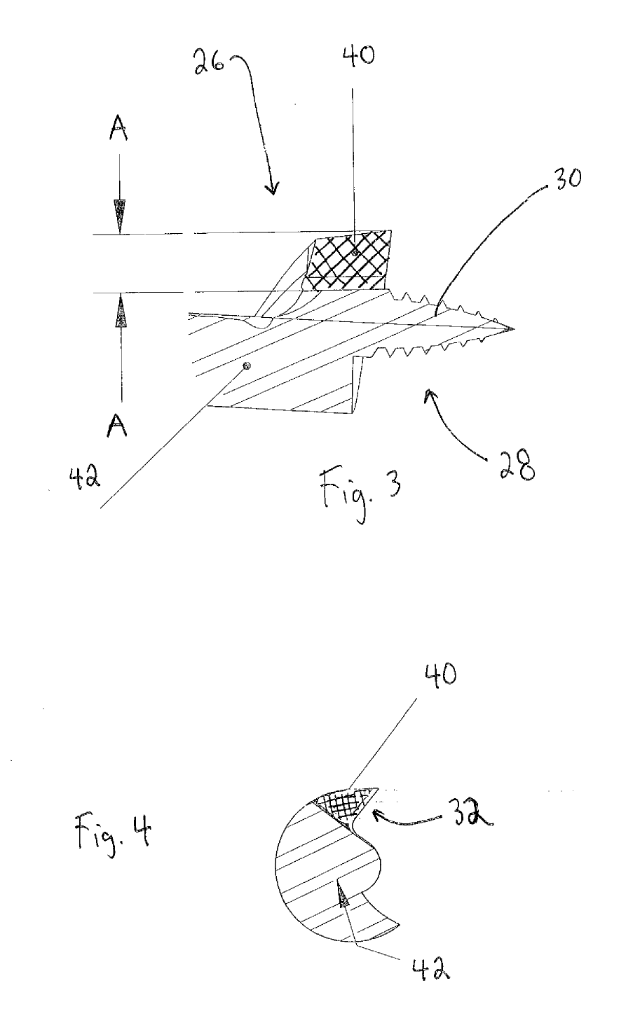

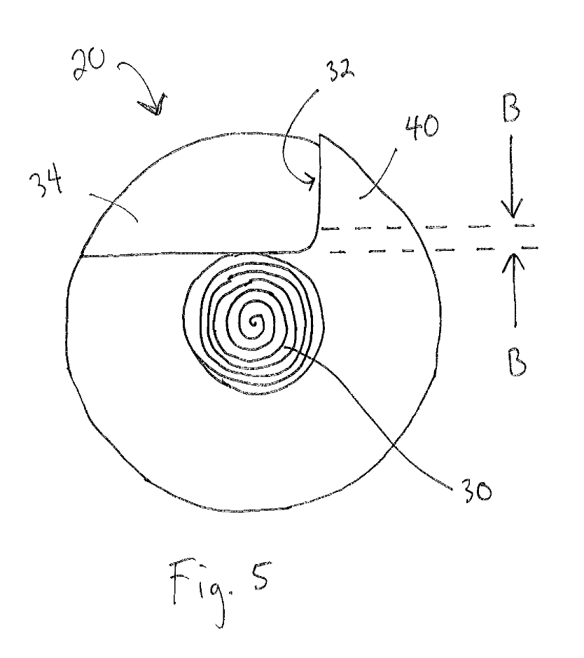

FIG. 3 is an axial cross-sectional view of the terminal portion of second end 26 and FIG. 4 is a radial cross-sectional view of the terminal portion of second end 26. Induction heat-treat zone 40 is shown in fine cross-hatching in FIGS. 3 and 4 and the core 42 of the auger bit 20 is shown in rough cross-hatching. Core 42 preferably has a hardness of 46 to 50 Rc produced by the initial neutral heat treatment. Induction heat-treat zone 40 preferably has a hardness of 55 to 60 Rc produced by a local induction heat treatment.

FIG. 5 is an end view of the auger bit 20, from second end 28. The radius 44 is the curve where cutting face 32 meets flute 34, between the two lines labeled B-B. Preferably, zone 40 extends into the radius 44, so that the minimum depth of zone 40 is where the radius 44 becomes tangent to the cutting face 32 and the maximum depth is where the radius 44 becomes perpendicular to the cutting face 32.

The auger bit 20 is preferably manufactured by machining a blank cylindrical shank to form a hexagonal cross-section at the first end 24 and a flute 34. Next, the cutting face 32 and the lead screw 30 are machined at the second end 26. The auger bit 20 is then subjected to a neutral heat treatment process, preferably in an atmosphere controlled batch furnace. The auger bit 20 is heated to at or above the critical heat treat temperature, is quenched in oil or other quenching fluid, is rinsed, and is then tempered in a temper furnace for stress relief. Preferably, this treatment achieves a hardness of 46 to 50 Rc.

If necessary, the auger bit 20 is then straightened and/or balanced. Long bits, such as 18-inch bits, are more likely to require straightening. Short bits are more likely to require balancing. Some auger bits, however, regardless of length, may require both straightening and balancing. If the auger bit 20 has become distorted during the neutral heat treatment, a straightening machine locates the worst-case bent location and applies a load to that location, bending the auger bit 20 in the opposite direction to meet and exceed the yield point of the material. Balancing is achieved by locating the auger bit 20 on the first end 24, rotating the auger bit 20, and applying a force opposite the direction of the greatest read-out reading.

The cutting face 32 is then subject to an induction heat treatment. Preferably, the auger bit 20 is placed in a tool, a magnetic field is applied to the cutting face 32 to heat the cutting face 32 to the critical induction heat treating temperature, and the heated material is then quenched, preferably by air quenching, to create induction heat treatment zone 40.

In the preferred embodiment, the hardness of the cutting face 32 increases, as a result of the local hardening heat treatment, to 55 to 60 Rc. This result is unexpected because the structure of the steel of the auger bit 20 has already changed to martensitic structure from the first, neutral heat treatment process, and the additional heating and cooling steps were expected to crack the cutting face 32.

The increased hardness of the cutting face 32 extends the life of the auger bit 20, which can now be used on average three times as long without having to be re-sharpened. Additionally, since induction heat treating is used, no coatings need be applied to portions of the auger bits 20 during the manufacturing process to produce local hardening of the cutting face 32. The elimination of the need for a coating improves the efficiency of the manufacturing process.

The complete preferred process of manufacture of the auger bit 20, not all of which steps are required for the present invention, is:
Step 1. Receive material, preferably an axially-elongated shank.
Step 2. Machine a blank to form a hex end at first end 24 and rough shape a cone at second end 26, preferably on a lathe.
Step 3. Machine a flute in the blank, preferably by whirling.
Step 4. Machine the final shape of head portion 28, preferably by milling.
Step 5. Machine screw point threads in lead screw 30.
Step 6. Neutral heat treat (preferably to 46 to 50 Rc).
Step 7. Temper for stress relief.
Step 8. Straighten (if necessary).
Step 9. Balance (if necessary).
Step 10. Machine for grind relief, preferably in a grinder, either an in-line grinder or a hand grinder, such as a pedestal grinder.
Step 11. Induction heat treat the cutting face 32 to produce the induction heat-treat zone 40 (local heat treat to increase hardness from 46 to 50 Rc to 55 to 60 Rc).
Step 12. Quench (preferably air quenching).
Step 13. Temper for stress relief.
Step 14. Package finished product.

While a preferred embodiment of the present invention is shown and described, it is envisioned that those skilled in the art may devise various modifications of the present invention without departing from the spirit and scope of the appended claims.

The invention claimed is:

1. An auger bit comprising:
an axially-elongated shank portion having a first end and a second end opposite the first end;
a tool-engaging portion on the first end of the shank; and
a work-entering head portion on the second end of the shank, the head portion comprising a cutting face;
wherein the auger bit is neutral hardened and the cutting face comprises a locally hardened induction heat treat zone produced by induction heat treating.

2. The auger bit of claim 1, wherein the locally hardened induction heat treat zone is hardened to about 55 to 60 Rc.

3. The auger bit of claim 3, wherein the cutting face is tempered.

4. A method of manufacturing an auger bit comprising:
machining a tool-engaging portion on a first end of an axially-elongated shank and a work-entering head portion on a second end of the shank, the work-entering head portion comprising a cutting face;
neutral heat treating the machined shank; and
locally heat treating the cutting face by induction.

5. The method of claim 4, wherein the step of locally heat treating the cutting face comprises hardening the cutting face to about 55 to 60 Rc.

6. The method of claim 4, wherein the step of locally heat treating the cutting face comprises applying a magnetic field to the cutting face, heating the cutting face to at least a critical induction heat treating temperature, and quenching the heated cutting face.

7. The method of claim 6, further comprising tempering the cutting face.

8. The method of claim 6, wherein the heated cutting face is quenched by air quenching.

9. An auger bit manufactured by the steps of:
machining a tool-engaging portion on a first end of an axially-elongated shank and a work-entering head portion on a second end of the shank, the work-entering head portion comprising a cutting face;
neutral heat treating the machined shank; and
locally heat treating the cutting face by induction.

10. The auger bit of claim 9, wherein the step of locally heat treating the cutting face comprises hardening the cutting face to about 55 to 60 Re.

11. The auger bit of claim 9, wherein the step of locally heat treating the cutting face comprises applying a magnetic field to the cutting face, heating the cutting face to at least a critical induction heat treating temperature, and quenching the heated cutting face.

12. The auger bit of claim 9, further comprising tempering the cutting face.

13. The auger bit of claim 12, wherein the quenching step comprises air quenching.
